(19) United States
(12) Patent Application Publication
(10) Pub. No.: US 2020/0385906 A1
(43) Pub. Date: Dec. 10, 2020

(54) STITCHING YARN AND NCF FABRIC CONTANING SUCH YARN

(71) Applicant: Cytec Industries Inc., Princeton, NJ (US)

(72) Inventors: Dominique PONSOLLE, Winona, MN (US); Carmelo Luca RESTUCCIA, Chester (GB); Andreas NAHR, Wrexham (GB); Pierre-Yves LAHARY, Lyon (FR); Jérôme BIKARD, Juan les Pins (FR)

(21) Appl. No.: 16/764,589

(22) PCT Filed: Dec. 4, 2018
(86) PCT No.: PCT/US2018/063786

§ 371 Date: May 15, 2020

Related U.S. Application Data
(60) Provisional application No. 62/594,129, filed on Dec. 4, 2017.

(51) Int. Cl. D04H 3/115; D04H 3/002; B29C 70/22; D04H 3/011; C08J 5/24

(52) U.S. Cl. CPC D04H 3/115; D04H 3/002; B29K 2277/00; D04H 3/011; C08J 5/24; B29C 70/226

(57) ABSTRACT

The present disclosure relates to a stitching yarn and non-crimp fabrics containing such yarn. The stitching yarn described herein is a multifilament stitching yarn characterized by two or more of the following properties: (a) comprises a plurality of polymeric fibers, (b) has a linear density of less than or equal to 80 dtex, (c) has a filament count of less than or equal to 0.8 times the dtex value of the stitching yarn, or (d) has a twist of less than 200 revolutions per meter (r/m). The present disclosure also relates to a fiber preform, composite material, and composite article containing the non-crimp fabric.

### CROSS REFERENCE TO RELATED APPLICATIONS

The present application claims priority to U.S. provisional application No. 62/594,129, filed Dec. 4, 2017, the entire contents of which is hereby incorporated by reference.

### FIELD OF THE INVENTION

The present invention relates to stitching yarns and NCF fabrics containing such yarns. The present invention further relates to preforms, composite materials, and composite articles containing the NCF fabrics described herein. The preforms, composite materials, and composite articles according to the present disclosure are particularly suited to the production of composite parts for use in many applications, such as in the aviation field as well as in the automobile and naval industries.

### BACKGROUND

Noncrimped fabrics (NCF) generally comprise one or more layers of structural fibers, filaments, or yarn, each layer having the fibers, filaments, or yarns oriented in discrete directions. The fibers, filaments, or yarn are also referred to as reinforcement fibers, filaments, or yarn. The layers are typically consolidated by a stitching yarn.

However, such stitching limits the expansion of the yarns within the layers at the points where the stitching penetrates the layers. The effect is the creation of separation zones, also called “fisheyes”, between the reinforcement yarns. At the point of stitching, the separation zone leaves a space that is then filled with resin and facilitates the undesirable formation of resin-rich zones when the NCF fabric is later combined with a resin matrix during the production of composite articles and/or parts.

The formation of resin-rich zones when NCF fabric is combined with a resin matrix during the production of a composite part leads to areas of non-uniform structure within the finished part where hygrothermal stress becomes concentrated. A composite part, when subjected to thermal cycles and humid periods, undergoes contraction and expansion stress and microcracks may develop at the resin-rich zones. Thus, there is an ongoing need to mitigate or prevent the appearance of microcracks in subsequently-produced composite parts that are subjected to hygrothermal stresses.

U.S. Pat. No. 9,695,533 to Beraud et al. and U.S. Pat. No. 8,613,257 to Wockatz describe strategies for minimizing the size of resin-rich zones in composite parts by reducing the titer of the stitching yarn in order to improve microcracking behavior of the composite and mechanical properties in in-plane direction of the composite, respectively.

Herein, a new strategy for limiting microcracking behavior of composite articles by reducing the size of the fisheyes in the NCF fabrics used to make them by engineering the stitching yarn is described.

### SUMMARY OF THE INVENTION

In a first aspect, the present disclosure relates to a non-crimp fabric comprising at least one layer of unidirectionally oriented multifilament carbon yarns and a multifilament stitching yarn interlinking the multifilament carbon yarns, wherein the stitching yarn is characterized by two or more of the following:
(a) comprises a plurality of polymeric fibers,
(b) has a linear density of less than or equal to 80 dtex,
(c) has a filament count of less than or equal to 0.8 times the dtex value of the stitching yarn, or
(d) has a twist of less than 200 revolutions per meter (r/m).

In a second aspect, the present disclosure relates to a fiber preform comprising the non-crimp fabric described herein.

In a third aspect, the present disclosure relates to a composite material, comprising:
a matrix resin, and
a non-crimp fabric described herein.

In a fourth aspect, the present disclosure relates to a composite article obtained by curing the composite material described herein.

In a fifth aspect, the present disclosure relates to a process for making an NCF fabric, the process comprising interlinking a plurality of multifilament carbon yarns into a unidirectionally oriented layer using a multifilament stitching yarn, wherein the stitching yarn is characterized by two or more of the following:
(a) comprises a plurality of polymeric fibers,
(b) has a linear density of less than or equal to 80 dtex,
(c) has a filament count of less than or equal to 0.8 times the dtex value of the stitching yarn, or
(d) has a twist of less than 200 revolutions per meter (r/m).

### BRIEF DESCRIPTION OF THE FIGURES

FIG. 1 shows a schematic diagram of a separation zone in an NCF fabric and the reduction in the size of the separation zone when a multifilament stitching yarn according to the present invention is used.

FIG. 2 shows a schematic diagram of (a) the effect of a stitching yarn having a high amount of twist, and (b) the effect of a stitching yarn having a low amount of twist.

### DETAILED DESCRIPTION

The present disclosure relates to a non-crimp fabric comprising at least one layer of unidirectionally oriented multifilament carbon yarns and a multifilament stitching yarn interlinking the multifilament carbon yarns, wherein the stitching yarn is characterized by two or more of the following:
(a) comprises a plurality of polymeric fibers,
(b) has a linear density of less than or equal to 80 dtex,
(c) has a filament count of less than or equal to 0.8 times the dtex value of the stitching yarn, or
(d) has a twist of less than 200 revolutions per meter (r/m).

As used herein, the terms “a”, “an”, or “the” means “one or more” or “at least one” unless otherwise stated.

As used herein, the term “comprises” includes “consists essentially of” and “consists of.” The term “comprising” includes “consisting essentially of” and “consisting of.”

The term “non-crimp fabric” or “non-crimped fabric”, sometimes “NCF”, refers to a construct comprising one or more layers of fibers, filaments, or yarns. The fibers, filaments, or yarns in a single layer are arranged such that they are parallel to each other and oriented in a single direction (i.e., unidirectional). Multiple layers may be stacked so that the fibers, filaments, or yarns of one layer are oriented parallel to the fibers, filaments, or yarns of an adjacent layer or are oriented crosswise to the fibers, filaments, or yarns of an adjacent layer. When the fibers, filaments, or yarns of one layer are oriented crosswise to the fibers, filaments, or yarns of an adjacent layer, the angles between the axis of one layer, the axis being determined by the direction of the fibers, filaments, or yarns in the layer, and that of the axis of the adjacent layer are virtually infinitely adjustable. For example, the angles between adjacent fiber layers may be 0° or 90°, or such angles plus or minus 25°, plus or minus 30°, plus or minus 45°, or plus or minus 60°, the zero-degree direction being determined by methods known to those of ordinary skill in the art. For example, the machine direction may be designated as the 0° direction. Accordingly, the term “multiaxial” refers to an NCF fabric having more than one layer, each layer oriented in various directions. Multiaxial fabrics include biaxial fabrics in which the layers are oriented in two directions and triaxial fabrics in which the layers are oriented in three directions, and so on. Multiaxial non-crimp fabrics can be produced e.g. by means of warp knitting looms or stitch bonding machines.

In an embodiment, the non-crimp fabric comprises one layer of unidirectionally oriented multifilament carbon yarns. In another embodiment, the non-crimp fabric comprises more than one layer of unidirectionally oriented multifilament carbon yarns. In an embodiment, the non-crimp fabric comprises more than one layer of unidirectionally oriented multifilament carbon yarns, which layers are oriented in the same direction. In another embodiment, the non-crimp fabric comprises more than one layer of unidirectionally oriented multifilament carbon yarns, which layers are oriented in different directions.

As used herein, a yarn is a continuous strand of one or more fibers, one or more filaments, or material in a form suitable for use in the production of textiles, sewing, crocheting, knitting, weaving, stitching, etc. Yarns include, for example, (1) a plurality of filaments laid or bundled together without applied or intentional twist, sometimes referred to as a zero-twist yarn or a non-twisted yarn; (2) a plurality of filaments laid or bundled together and are either interlaced, have false-twist, or are textured in some manner; (3) a plurality of filaments laid or bundled together with a degree of twist, sometimes referred to as a twisted yarn; (4) a single filament with or without twist, sometimes referred to a monofilament or monofilament yarn. Textured yarns may be filament or spun yarns that have been given noticeably greater volume through physical, chemical, or heat treatments or a combination of these. In some instances a yarn is called a filament yarn or a multifilament yarn, both of which are generally yarns made from a plurality of filaments.

As used herein, “fiber” refers to a material having a high ratio of length to thickness. Fibers may be continuous, in which case such fibers are referred to as filaments, or staple length (i.e., discrete length).

The unidirectionally oriented multifilament carbon yarns within a single layer of the NCF of the present disclosure are interlinked by a multifilament stitching yarn having certain properties that contribute to reducing the size of fisheyes in the NCF fabric, and, thus, reducing the size of undesirable resin-rich zones in composite articles made from the NCF fabric.

The polymeric fibers of the multifilament stitching yarn may be fibers of polyamides such as aliphatic polyamides (PA), cycloaliphatic polyamides, aromatic polyamides, polyphthalamides (PPA), ether or ester block polyamides (PEBAX, PEBA), polyesters such as polyethyleneterephthalates (PET), polyethylenenaphthalates (PEN) and Polytrimethylene terephthalate (PTT), polyolefins such as polypropylenes (PP), polyethylenes (PE), thermoplastic polyolefins (TPO) such as Ethylene Propylene Diene (EPDM) and Ethylene Propylene (EPR) rubbers, polyphenylene sulfides (PPS), polyetherimides (PEI), polyimides (PI), polyimides having phenyltrimethylindane structure, polyamidoamides (PAI), polysulfones, polyarylsulfones such as polyethersulfone (PES), polyethersulfone-etherethersulfone (PES: PEES), polyetherethersulfone (PEES), polyketones, polyaryletherketone (PAEK) such as polyetherketone (PEK), polyetheretherketone (PEEK) and polyetherketoneketones (PEKK), polyurethanes, polyether or polyester-b-urethanes, thermoplastic polyurethanes, polycarbonates, polyacetals, polyphenyleneoxides (PPO), polyethers, polyethernitriles, polybenzimidazoles, thermoplastic elastomers, such as Styrene Ethylene Butylene Styrene (SEBS), Styrene Ethylene Propylene Styrene (SEPS) and Styrene Butylene Styrene (SBS) block copolymers and hydrogenated versions thereof, vulcanized thermoplastic elastomers (TPV) such as vulcanized Ethylene Propylene Diene block copolymers; liquid crystal polymers (LCPs), and combinations and copolymers thereof.

In an embodiment, the polymeric fibers of the multifilament stitching yarn are polyamide, polyester, polyhydroxyethers, or copolymers thereof. In another embodiment, the polymeric fibers of the multifilament stitching yarn comprise PA 6, PA 6/6, PA 6T, PA 12, PA 6/10, PA 9T, PA 10/10, PA 10T, PA11, PA 6/12, PA 10/12, or blends or copolymers thereof.

The polymeric fibers of the multifilament stitching yarn may be characterized by density. As used herein, the density refers to the density of the polymer material used in manufacturing the fibers. The polymeric fibers of the multifilament stitching yarn have a density of from 0.5 to 2.0 g/cm³, typically from 0.8 to 1.8 g/cm³, more typically from 0.9 to 1.5 g/cm³. In an embodiment, the polymeric fibers of the multifilament stitching yarn have a density of from 0.9 to 1.4 g/cm³.

The multifilament stitching yarn may be characterized by certain properties, such as linear mass density and/or filament count (when the yarn comprises more than one filament).

The linear mass density of the yarn is given in units of tex, or more commonly decitex (dtex). One tex is defined as the mass in grams per 1000 meters of the yarn. Accordingly, one dtex is the mass in grams per 10,000 meters of yarn. In accordance with the present invention, the linear density of the multifilament stitching yarn is less than or equal to 80 dtex. Typically, the linear density is in the range of 1 to 60 dtex, more typically 1 to 40 dtex.

A multifilament stitching yarn may be characterized by filament count, which is the number of filaments making up the yarn. The filament count of the multifilament stitching yarn is less than or equal to 1.0 times the dtex value of the stitching yarn, typically less than or equal to 0.9 times the dtex value, more typically less than or equal to 0.8 times the dtex value.

In some embodiments, the filament count is in the range of 0.1 to 0.8 times the dtex value of the yarn, typically 0.1 to 0.6 times the dtex value of the yarn, more typically 0.1 to 0.5 times the dtex value of the yarn.

The fibers or filaments of the multifilament stitching yarn may be interlaced, also referred to as entangled or intermingled, according to methods known to those of ordinary-skill in the art. For example, yarn filaments may be interlaced by exposing a plurality of filaments to a localized fluid jet, such as an air stream. Interlacing gives rise to points of entanglement, called nodes, which are separated by spaces of unentangled filaments. Thus, the extent of interlacing is typically given as the number of nodes per meter of yarn. The extent of interlacing of the multifilament stitching yarn is less than 25 nodes/meter.

In an embodiment, the non-crimp fabric is multiaxial and comprises more than one layer of unidirectionally oriented multifilament carbon yarns. The layers of a multiaxial NCF fabric can be connected and secured to each other according to methods known to those of ordinary skill in the art, for example, by a plurality of stitching or knitting threads arranged parallel to each other and running parallel to each other and forming stitches. The stitching or knitting threads used to connect and secure the layers of the multiaxial NCF fabric to each other may be the same as or different from the multifilament stitching yarn described herein. In an embodiment, the stitching or knitting threads used to connect and secure the layers of the multiaxial NCF fabric to each other is the same as the multifilament stitching yarn described herein.

The multifilament stitching yarn holds together the unidirectionally oriented multifilament yarns within a single layer of the NCF and/or secures two or more layers in the NCF fabric to one another, and does not provide any structural reinenforcement. Thus, the multifilament stitching yarn used according to the present disclosure for interlinking of the unidirectionally oriented multifilament carbon yarns within a single layer of the NCF and/or the consolidation of two or more layers in the NCF fabric is non-structural. In contrast, the unidirectionally oriented multifilament carbon yarns are structural as they provide structural reinforcement in a composite material or article made therefrom.

The non crimp fabric may further comprise one or more layers of a nonwoven veil. For example, the non crimp fabric may comprise a layer of unidirectionally oriented multifilament carbon yarns combined with a layer of a nonwoven veil. Any nonwoven veil known to those of ordinary skill in the art may be used. The layers constituting the NCF fabric, including the one or more layers of nonwoven veil, can be connected and secured to each other according to methods known to those of ordinary skill in the art, for example, by a plurality of stitching or knitting threads. The nonwoven veil layer, when used, advantageously provides improved process performance, such as permeability, as well as mechanical performance, such as impact and delamination resistance. Exemplary nowwoven veils that may be used are described in PCT Publications WO 2017/083631 and WO 2016/003763, which are incorporated by reference.

The interlinking of the unidirectionally oriented multifilament carbon yarns within a single layer of the NCF and/or the consolidation of two or more layers in the NCF fabric may be achieved using various stitch types, stitch width (i.e., the distance between the points in the weft direction), and stitch lengths (i.e., the distance between the points in the warp direction) known to those of ordinary skill in the art. Suitable stitch patterns include straight stitches, chain stitches, lock stitches, zig-zag stitches, tricot stitches, or a combination thereof. In an embodiment, the stitch pattern is a tricot stitch. There is no particular limitation to the stitch width and the stitch length that may be used. For example, the stitch width may be in the range of 1 to 20 mm, typically 1 to 10 mm. The stitch length may be in the range of 1 to 20 mm, typically 1 to 10 mm, for instance.

The present disclosure also relates to a fiber preform comprising the non-crimp fabric described herein. The fiber preform comprises at least one layer of the non-crimp fabric.

As used herein, the term “preform” refers to a construct in which one or more layers of reinforcement material, such as the NCF fabric described herein, are laid without matrix resin in a mold for further processing, such as infusion or injection of matrix resin, to form a composite material or article.

The fiber preform may further comprise layers of any type of textiles known to those of ordinary skill for manufacturing composite materials. Examples of suitable fabric types or configurations include, but are not limited to: all woven fabrics, examples of which are plain weave, twill weave, sateen weave, spiral weave, and uni-weave fabrics; warp-knitted fabrics; knitted fabrics; braided fabrics; all non-woven fabrics, examples of which include, but are not limited to, nonwoven veils, mat fabrics composed of chopped and/or continuous fiber filaments, felts, and combinations of the aforementioned fabric types.

In an embodiment, the fiber preform may further comprise a non-woven veil. Any non-woven veils known to those of ordinary skill in the art may be used. For example, the veil described in PCT International Publication WO 2017/083631 may be used. A binder component may be distributed on at least one side of the nonwoven veil layer or penetrated through portions of the nonwoven veil, or distributed throughout the non-crimp fabric, including in spaces between the unidirectionally oriented fibers and on portions of the veil. For example, the binders described in PCT International Publication WO 2016/003763, which is incorporated herein by reference, may be used. The binder may be present in an amount less than or equal to 15% by weight or less of the final fabric. Typically, the binder component does not form a continuous film at the surface of the fibrous material.

The present disclosure relates to a process for making an NCF fabric, the process comprising interlinking a plurality of multifilament carbon yarns into a unidirectionally oriented layer using a multifilament stitching yarn, wherein the stitching yarn is characterized by two or more of the following:
(a) comprises a plurality of polymeric fibers,
(b) has a linear density of less than or equal to 80 dtex,
(c) has a filament count of less than or equal to 0.8 times the dtex value of the stitching yarn, or
(d) has a twist of less than 200 revolutions per meter (r/m).

The interlinking of the plurality of multifilament carbon yarns into a unidirectionally oriented layer is achieved using the multifilament stitching yarn described herein.

When the NCF fabric comprises more than one layer, the multiple layers may be connected and secured to each other by stitching or knitting according to known methods using a stitching yarn, such as the multifilament stitching yarn described herein. When the NCF fabric is multiaxial, the production of such multiaxial NCF is known and makes use of conventional techniques, described, for instance, in the book “Textile Structural Composites, Composite Materials Series Volume 3” by Tsu Wei Chou & Franck K. Ko, ISBN-0-44442992-1, Elsevier Science Publishers B. V., 1989, Chapter 5, paragraph 3.3.

Composite materials may be made by molding a preform and infusing the preform with a thermosetting resin in a number of liquid-molding processes. Liquid-molding processes that may be used include, without limitation, vacuum-assisted resin transfer molding (VARTM), in which resin is infused into the preform using a vacuum-generated pressure differential. Another method is resin transfer molding (RTM), wherein resin is infused under pressure into the preform in a closed mold. A third method is resin film infusion (RFI), wherein a semi-solid resin is placed underneath or on top of the preform, appropriate tooling is located on the part, the part is bagged and then placed in an autoclave to melt and infuse the resin into the preform.

Thus, the present disclosure also relates to a composite material, comprising:
a matrix resin, and
a non-crimp fabric described herein.

The matrix resin for impregnating or infusing the preforms described herein is a curable resin. “Curing” or “cure” in the present disclosure refers to the hardening of a polymeric material by the chemical cross-linking of the polymer chains. The term “curable” in reference to a composition means that the composition is capable of being subjected to conditions which will render the composition to a hardened or thermoset state. The matrix resin is typically a hardenable or thermoset resin containing one or more uncured thermoset resins. Suitable matrix resins include, but are not limited to, epoxy resins, oxetanes, imides (such as polyimide or bismaleimide), vinyl ester resins, cyanate ester resins, isocyanate-modified epoxy resins, phenolic resins, furanic resins, benzoxazines, formaldehyde condensate resins (such as with urea, melamine or phenol), polyesters, acrylics, hybrids, blends and combinations thereof.

Suitable epoxy resins include glycidyl derivatives of aromatic diamine, aromatic mono primary amines, aminophenols, polyhydric phenols, polyhydric alcohols, polycarboxylic acids and non-glycidyl resins produced by peroxidation of olefinic double bonds. Examples of suitable epoxy resins include polyglycidyl ethers of the bisphenols, such as bisphenol A, bisphenol F, bisphenol S, bisphenol K and bisphenol Z; polyglycidyl ethers of cresol and phenol-based novolacs, glycidyl ethers of phenol-aldelyde adducts, glycidyl ethers of aliphatic dials, diglycidyl ether, diethylene glycol diglycidyl ether, aromatic epoxy resins, aliphatic polyglycidylethers, epoxidised olefins, brominated resins, aromatic glycidyl amines, heterocyclic glycidyl imidines and amides, glycidyl ethers, fluorinated epoxy resins, or combinations thereof.

Specific examples are tetraglycidyl derivatives of 4,4′-diaminodiphenylmethane (TGDDM), resorcinol diglycidyl ether, triglycidyl-p-aminophenol, triglycidyl-m-aminophenol, bromobisphenol F diglycidyl ether, tetraglycidyl derivatives of diaminodiphenylmethane, trihydroxyphenyl methane triglycidyl ether, polyglycidylether of phenol-formaldehyde novolac, polyglycidylether of o-cresol novolac or tetraglycidyl ether of tetraphenylethane.

Suitable oxetane compounds, which are compounds that comprise at least one oxetano group per molecule, include compounds such as, for example, 3-ethyl-3[[(3-ethyloxetane-3-yl)methoxy]methyl]oxetane, oxetane-3-methanol, 3,3-bis-(hydroxymethyl) oxetane, 3-butyl-3-methyl oxetane, 3-methyl-3-oxetanemethanol, 3,3-dipropyl oxetane, and 3-ethyl-3-(hydroxymethyl) oxetane.

The curable matrix resin may optionally comprise one or more additives such as curing agents, curing catalysts, co-monomers, rheology control agents, tackifiers, inorganic or organic fillers, thermoplastic and/or elastomeric polymers as toughening agents, stabilizers, inhibitors, pigments, dyes, flame retardants, reactive diluents, UV absorbers and other additives well known to those of ordinary skill in the art for modifying the properties of the matrix resin before and/or after curing.

Examples of suitable curing agents include, but are not limited to, aromatic, aliphatic and alicyclic amines, or guanidine derivatives. Suitable aromatic amines include 4,4′-diaminodiphenyl sulphone (4,4′-DDS), and 3,3′diaminodiphenyl sulphone (3,3′-DDS), 1,3-diaminobenzene, 1,4-diaminobenzene, 4,4′-diammodiphenylmethane, benzenediamine(BDA); Suitable aliphatic amines include ethylenediamine (EDA), 4,4′-methylenebis(2,6-diethylaniline) (M-DEA), m-xylenediamine (mXDA), diethylenetriamine (DETA), triethylenetetramine (TETA), trioxatridecanediamine (TTDA), polyoxypropylene diamine, and further homologues, alicyclic amines such as diaminocyclohexane (DACH), isophoronediamine (IPDA), 4,4′ diamino dicyclohexyl methane (PACM), bisaminopropylpiperazine (BAPP), N-aminoethylpiperazine (N-AEP); Other suitable curing agents also include anhydrides, typically polycarboxylic anhydrides, such as nadic anhydride, methylnadic anhydride, phthalic anhydride, tetrahydrophthalic anhydride, hexahydrophthalic anhydride, methyltetrahydrophthalic anhydride,methylhexahydrophthalic anhydride, endomethylene-tetrahydrophtalic anhydride, pyromellitic dianhydride, chloroendic anliydride and trimellitic anhydride.

Still other curing agents are Lewis acid:Lewis base complexes. Suitable Lewis acid:Lewis base complexes include, for example, complexes of: BCI₃:amine complexes, BF₃:amine complexes, such as BF₃:monoethylamine, BF₃:propylamine, BF₃:isopropyl amine, BF₃:benzyl amine, BF₃:chlorobenzyl amine, BF₃:trimethylamine, BF₃:pyridine, BF₃:THF, AlCl₃:THF, AlCl₃:acetonitrile, and ZnCl₂:THF.

Additional curing agents are polyamides, polyamines, amidoamines, polyamidoamines, polycycloaliphatic, polyetheramide, imidazoles, dicyandiamide, substituted ureas and urones, hydrazines and silicones.

Urea based curing agents are the range of materials available under the commercial name DYHARD (marketed by Alzchem), and urea derivatives, such as the ones commercially available as UR200, UR300, UR400, UR600 and UR700. Urone accelerators include, for example, 4,4-methylene diphenylene bis(N,N-dimethyl urea) (available from Onmicure as U52 M).

When present, the total amount of curing agent is in the range of 1 wt % to 60 wt % of the resin composition. Typically, the curing agent is present in the range of 15 wt % to 50 wt %, more typically in the range of 20 wt % to 30 wt %.

Suitable toughening agents may include, but are not limited to, homopolymers or copolymers either alone or in combination of polyamides, copolyamides, polyimides, aramids, polyketones, polyetherimides (PEI), polyetherketones (PEK), polyetherketoneketone (PEKK), polyetheretherketones (PEEK), polyethersulfones (PES), polyetherethersulfones (PEES), polyesters, polyurethanes, polysulphones, polysulphides, polyphenylene oxide (PPO) and modified PPO, poly(ethylene oxide) (PEO) and polypropylene oxide, polystyrenes, polybutadienes, polyacrylates, polystyrene, polymethacrylates, polyacrylics, polyphenylsulfone, high performance hydrocarbon polymers, liquid crystal polymers, elastomers, segmented elastomers and core-shell particles.

Toughening particles or agents, when present, may be present in the range 0.1 wt % to 30 wt % of the resin composition. In an embodiment, the toughening particles or agents may be present in the range 10 wt % to 25 wt %. In another embodiment, the toughening particles or agents may be present in the range from 0.1 to 10 wt %. Suitable toughening particles or agents include, for example, Virantage VW10200 FRP, VW10300 FP and VW10700 FRP from Solvay, BASF Ultrason E2020 and Sumikaexcel 5003P from Sumitomo Chemicals.

The toughening particles or agents may be in the form of particles having a diameter less than or equal to 5 microns, typically less than or equal to 1 micron in diameter. The size of the toughening particles or agents may be selected such that they are not filtered by the fiber reinforcement. Optionally, the composition may also comprise silica-gels, calcium-silicates, silica oxide, phosphates, molybdates, fumed silica, amorphous silica, amorphous fused silica, clays, such as bentonite, organo-clays, aluminium-trihydrates, hollow glass microspheres, hollow polymeric microspheres, microballoons and calcium carbonate.

The composition may also contain conductive particles such as the ones described in PCT International Publications WO 2013/141916, WO 2015/130368 and WO 2016/048885.

The carbon of the multifilament carbon yarns may be in the form of graphite. The carbon may be metallized with discontinuous or continuous metal layers. Graphite fibers which have been found to be especially useful in the invention are those supplied by Solvay under the trade designations T650-35, T650-42 and T300; those supplied by Toray under the trade designation T700, T800 and T1000; and those supplied by Hexcel under the trade designations AS4, AS7, IM7, IM8 and IM10. The carbon fibers, typically filaments, may be unsized or sized with a material that is compatible with the resin composition.

The mold for resin infusion may be a two-component, closed mold or a vacuum bag sealed, single-sided mold. Following infusion of the matrix resin in the mold, the mold is heated to cure the resin to produce a composite article, which is a finished part.

Thus, the present disclosure relates to a composite article obtained by curing the composite material described hereinabove.

During heating, the resin reacts with itself to form crosslinks in the matrix of the composite material. After an initial period of heating, the resin gels. Upon gelling, the resin no longer flows, but rather behaves as a solid. After gel, the temperature or cure may be ramped up to a final temperature to complete the cure. The final cure temperature depends on the nature and properties of the thermosetting resin chosen. Thus, in an embodiment, the composite material is heated to a first temperature suitable to gel the matrix resin, after which the temperature is ramped up to a second temperature and held for a time at the second temperature to complete the cure.

The effect of consolidating the yarns within in a single layer of an NCF fabric and/or connecting and securing a plurality of layers of yarns by stitching is the formation of a space, or separation zone, left by the displacement of the yarns due to the penetration of the stitching thread. The separation zone has an elongated, lenticular shape, hence the term “fisheye”. Similar to an ellipse, the shape of a separation zone can be characterized by a major axis and a minor axis. Herein, the separation zone width, sometimes called fisheye width, is measured at the widest part along the minor axis.

The separation zones create empty spaces at the point of stitching. The spaces are later filled with resin and facilitate the undesirable formation of resin-rich zones during the production of composite articles and/or parts. The resin-rich zones within a composite part represent areas of non-uniform structure where hygrothermal stress becomes concentrated. A composite part, when subjected to thermal cycles and humid periods, undergoes contraction and expansion. As a result of the difference in structure of the resin-rich zones and other areas of the composite, hygrothermal stress is concentrated at the resin-rich zones, which may contribute to microcracking.

Thus, it is believed that the size of the separation zones is at least a contributing factor to the presence of microcracking in a composite article and it is believed that the reducing the size of the separation zone would contribute to the reduction of microcracking, or elimination of microcracking.

The multifilament stitching yarn having the properties described herein, when used to interlink the unidirectionally oriented multifilament carbon yarns within a single layer of the NCF and/or used to connect and secure multiple layers of unidirectionally oriented multifilament carbon yarns, contribute to reducing the size of fisheyes in the NCF fabric and/or preforms, and, thus, reducing the size of resin-rich zones in the composite articles made therefrom.

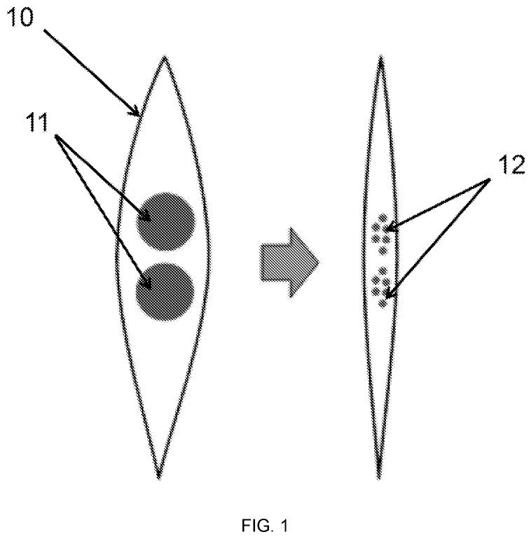

FIG. 1 shows a schematic diagram of a separation zone (10) in an NCF fabric and the reduction in the size of the separation zone when a multifilament stitching yarn according to the present invention is used. The large circles (11) represent the cross-sections of non-inventive stitching yarns and the small circles (12) represent the cross-sections of the inventive multifilament stitching yarns.

As shown in FIG. 1, smaller separation zones, or fisheyes, are achieved when the filaments of the multifilament stitching yarns line up, thereby facilitating a narrowing effect that minimizes the size of the separation zone.

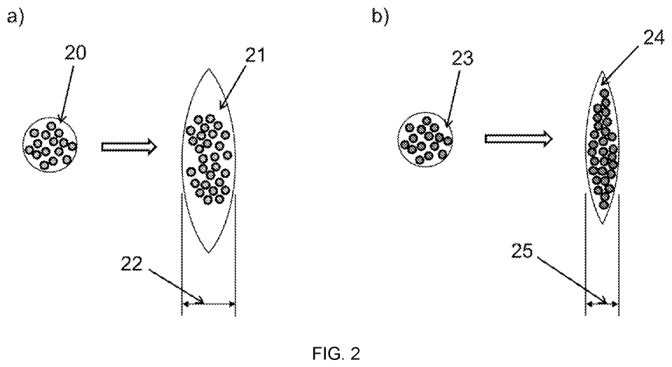

The size of the separation zone may also be impacted by the twist of the multifilament stitching yarn used to consolidate the yarns within in a single layer of an NCF fabric and/or connecting and securing a plurality of layers of yarns. As used herein, twist refers to the spiral arrangement of the fibers or filaments around the axis of a yarn. The multifilament stitching yarn of the present disclosure may or may not contain twist. Twist, when present, is provided as the number of revolutions per unit length, typically revolutions per meter. As shown in FIG. 2a, a yarn having a high amount of twist (20) induces a fisheye (21) having a large distance (22) as the yarn is more restricted from lining up and facilitating a narrowing effect. However, as shown in FIG. 2b, a yarn having a low amount of twist (23) induces a fisheye (24) having a narrower distance (25) as the yarn is less restricted from lining up and facilitating a narrowing effect.

Thus, the multifilament stitching yarn described herein has a low amount of twist. The multifilament stitching yarn has a twist of less than 200 revolutions per meter. In an embodiment, the stitching yarn has a twist of less than 150 r/m, typically less than 100 r/m, more typically less than 50 r/m. In an embodiment, the stitching yarn has no twist.

Other parameters that may influence the size of the separation zones is the tension and its control on the stitching yarn during its insertion into the NCF, the tension and its control on the carbon fibers, the influence of the carbon areal weight, the orientation of the carbon ply and the stitching pattern combined with the stitching length, among others.

The tension and its control as applied to the stitching yarn is adjustable and its level is selected based on a combination of several parameters that include, for example, the stitching yarn attributes, stitching pattern, and desired drape, among others. While there is no particularly limitation on the tension applied to the stitching yarn during its insertion into the NCF, the tension typically applied to the stitching yarn is low, as the result are narrower separation zones.

The tension and its control on the carbon fibers depends on the quality of the preparation of the carbon tows before laydown and the quality of the preparation after they have been laid down and clamped to the machine conveyor. While there is no particular limitation on the tension on the carbon fibers, a higher tension typically results in narrower separation zones.

Any method known to those of ordinary skill in the art may be used to measure the separation zone width within the NCF fabric, preform, composite material, and/or composite article. For example, optical microscopy may be used to visualize the separation zones and measurements made using digital imaging software.

Typically, the separation zone width within the NCF fabric, preform, composite material, and/or composite article is less than or equal to 300 microns, typically less than or equal to 100 microns.

The NCF fabric, stitching yarn, and the preform, composite material, and composite article made therefrom according to the present disclosure are further illustrated by the following non-limiting examples.

### EXAMPLES

Unless otherwise stated, all NCF fabrics were manufactured using 2 plies of carbon fiber with directions of ±45° and areal weight per ply of 268 gsm (grams per square meter). The machine gauge was an E5 and the stitch pattern was a tricot stitch. Stitch density was 12 stitches per inch. Various stitching yarns were used.

The measurement of the fisheyes was done on both faces of the fabric using an optical microscope with a magnification of 50X. Observations were done under dark field mode and focus was done on the edges of the carbon fiber bed on both sides of the fisheye. The minor axis length of the fisheye, or fisheye width, was then measured. Ten measurements were done per fabric sample along a 90 degree virtual line to the fabric direction. Measurements were done separately on both top and bottom faces of the fabric, plotted, and analyzed.

### Example 1

A 55-dtex stitching yarn having only 8 filaments and a twist of less than 200 r/m (EMS Grillon K140) was used to manufacture the NCF fabric. The fisheye width of the resulting NCF fabric was about 100 microns.

Composite articles were formed from the NCF fabric and were subjected up to 1600 hygrothermal cycles. No microcracking was observed in the composite articles under 100× magnification under bright field light or fluorescent light.

### Example 2

A PET multifilament stitching yarn of 36 dtex and having 24 filaments with no twist but low intermingling and a density 1.38 g/cm³ was used to manufacture NCF fabric. The resulting NCF fabric had a fisheye width of about 80 microns.

### Example 3

PA 10/10 stitching yarn of 39 dtex having 34 filaments and density of 1.04 g/cm³ with no twist and no intermingling (Solvay) was used to manufacture NCF fabric. The resulting NCF fabric had a fisheye width of about 90 microns.

1. A non-crimp fabric comprising at least one layer of unidirectionally oriented multifilament carbon yarns and a multifilament stitching yarn interlinking the multifilament carbon yarns, wherein the stitching yarn is characterized by two or more of the following:
(a) comprises a plurality of polymeric fibers,
(b) has a linear density of less than or equal to 80 dtex,
(c) has a filament count of less than or equal to 0.8 times the dtex value of the stitching yarn, or
(d) has a twist of less than 200 revolutions per meter (r/m).

2. The non-crimp fabric of claim 1, wherein the polymeric fibers are polyamide, co-polyamide, polyester, or co-polyester fibers.

3. The non-crimp fabric of claim 1, wherein the linear density of the multifilament stitching yarn is in the range of 1 to 60 dtex.

4. The non-crimp fabric of claim 1, wherein the filament count of the multifilament stitching yarn is in the range of 0.1 to 0.8 times the dtex value of the yarn.

5. The non-crimp fabric of claim 1, wherein the stitching yarn has a twist of less than 150 r/m.

6. The non-crimp fabric of claim 1, wherein the stitching yarn has no twist.

7. The non-crimp fabric of claim 1, wherein the polymeric fibers have a density of from 0.5 to 2.0 g/cm³.

8. The non-crimp fabric of claim 1, wherein the polymeric fibers have a density of from 0.9 to 1.4 g/cm³.

9. The non-crimp fabric of claim 1, wherein the stitching yarn has interlacing of less than 25 nodes/meter.

10. The non-crimp fabric of claim 1, wherein the non-crimp fabric is multiaxial and comprises more than one layer of unidirectionally oriented multifilament carbon yarns.

11. The non-crimp fabric of claim 1, further comprising a non-woven veil.

12. A fiber preform comprising the non-crimp fabric according to claim 1.

13. The fiber preform according to claim 12, further comprising a non-woven veil.

14. A composite material, comprising:
a matrix resin, and
a non-crimp fabric according to claim 1.

15. A composite article obtained by curing the composite material according to claim 14.

16. A process for making a non-crimp fabric according to claim 1, the process comprising interlinking a plurality of multifilament carbon yarns into a unidirectionally oriented layer using a multifilament stitching yarn, wherein the stitching yarn is characterized by two or more of the following:
(a) comprises a plurality of polymeric fibers,
(b) has a linear density of less than or equal to 80 dtex,
(c) has a filament count of less than or equal to 0.8 times the dtex value of the stitching yarn, or
(d) has a twist of less than 200 revolutions per meter (r/m).

17. The non-crimp fabric of claim 3, wherein the linear density of the multifilament stitching yarn is in the range of 1 to 40 dtex.

18. The non-crimp fabric of claim 4, wherein the filament count of the multifilament stitching yarn is in the range of 0.1 to 0.6 times the dtex value of the yarn.

19. The non-crimp fabric of claim 5, wherein the stitching yarn has a twist of less than 100 r/m.

20. The non-crimp fabric of claim 7, wherein the polymeric fibers have a density of from 0.8 to 1.8 g/cm³.
